(19) United States
(12) Patent Application Publication
(10) Pub. No.: US 2012/0191979 A1
(43) Pub. Date: Jul. 26, 2012

(54) SYSTEM AND METHOD FOR ELECTRONIC SIGNATURE VIA PROXY

(76) Inventor: Michael Feldbau, Givatayim (IL)

(21) Appl. No.: 13/498,920

(22) PCT Filed: Sep. 19, 2010
(86) PCT No.: PCT/IL10/00769

§ 371 Date: Mar. 29, 2012

(30) Foreign Application Priority Data
Oct. 1, 2009 (IL) 201351

(51) Int. Cl. H04L 9/32

(52) U.S. Cl. 713/178; 713/176

(57) ABSTRACT

A system and method are disclosed for providing proxy signature to user documents comprised of an identification and authentication system, input means to enable providing identification information by the user to the identification and authentication system, authentication input means to enable providing authentication information by the user to the system, an electronic signature system, and a documents server for receiving documents from the user for electronic signature The system may comprise a storage device, an identification sub-system adapted to receive identification information from said user via said information input means and store the identification information in the storage device, an authentication sub-system adapted to authenticate the identity of the user based on information stored in said storage device and information provided by the user during authentication process via said authentication information input means The electronic signature system is adapted to apply a signature to documents provided by the user.

### BACKGROUND OF THE INVENTION

Current legislation related to electronic signatures provides the framework whereby people can electronically sign electronic documents, which in turn are accepted and treated as if they were original signed paper documents.

In the context of the present invention, the term “electronic signature” refers to the electronic expression of a lawful signature, which may be an electronic sound, symbol, data or process, attached to or logically associated with a record and executed or adopted by a person with the intent to sign a record.

Digital Signatures are implementations of electronic signatures that are widely used. Typically, Digital Signatures are generated by encrypting digital data or a hash thereof with a private (secret) key. The private key is typically stored in a secure location and/or on a secure device, and often further requires the use of a password to gain access to it. When implementing what is known as Symmetric Cryptosystem, both the signer and the verifier use the same encryption (“symmetric”) key.

When implementing what is known as Asymmetric or Public-Key Cryptosystem, the signer utilizes a private key to sign the documents, and the verifier utilizes a related (different) public key to verify the signatures. Public Key Digital Signatures provide the capability to authenticate both the signer and the integrity of electronic documents, and also provide for non-repudiation of the signer, and the ability to verify the signature without using the private key, but rather with a separate, related public key. Public Key cryptosystems also provide for secure transmissions over insecure channels like the Internet.

Throughout this document, the terms electronic signatures and digital signatures are used interchangeably, and they should be interpreted as referring to electronic signatures in general, and also to digital signatures where applicable.

Electronic correspondence is already wide spread. There is a vast migration to the electronic media, and people use paper documents mostly only when they are forced to do so. Documents which need to be signed by their originator, including inter alia official forms and applications, contracts and other legal documents still need to be sent on paper or by fax, rather than via e-mail, the reason being that they need to be signed while electronic signatures are not at hand.

Technical problems mainly hinder the quick spreading of the usage of electronic signatures. The problem preventing spreading of use of electronic signatures by the public seems to lie in the implementation of electronic signing: people need to register with a certified registrar, go through a tedious process of authentication, obtain some sort of “secret key”, which typically involves some piece of hardware such as an electronic card, a card reader, a USB dongle or alike, install some software and a key on one's computer, learn how to operate and utilize the private key, and worse yet—be bound to the computer having the card reader or the dongle to be able to use the electronic private key in order to electronically sign documents.

### SUMMARY OF THE INVENTION

A system for providing proxy signature to user documents is described. The system is associated with a proxy of the user, and while the terms “System” and “proxy” are used herein interchangeably, they refer to a system acting as a proxy with respect to the user. The system may be owned or operated by a person or entity who owns an electronic signature, and to whom the user delegates signature rights to and empowers to sign on his behalf.

The system may comprise identification and authentication system, an information input means to enable providing identification information by the user to the identification and authentication system; and an authentication information input means to enable providing authentication information by the user to the identification and authentication system. The identification and authentication system may further comprise a storage device, an identification sub-system adapted to receive identification information from said user via said information input means and store said identification information in said storage device, an authentication sub-system adapted to authenticate the identity of said user based on information stored in said storage device and information provided by user during authentication process via said authentication information input means.

The system may further comprise a document server, to which according to some embodiments, the documents may be uploaded by a user or sent via e-mail. Upon identification and authentication of the user, the proxy signs digitally or electronically, on behalf of the user, the documents provided by the user.

According to the present invention, people who do not own electronic signature means, may now fill-in electronic forms and applications and send them promptly for example by e-mail to their proxy, which in turn signs them on behalf of the sender, and optionally submits the signed documents to a designated recipient. The proposed solution may be suitable for various applications requiring a user's signature, including, inter alia, signing of electronic contracts, electronic orders, electronic invoices, electronic tax reports, electronic official forms, medical prescriptions and effectively any admissible electronically signed document.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram of a system according to one embodiment of the present invention;

FIG. 2 is a schematic flowchart of a method for authenticating and providing means for authenticated communication between a user and a proxy according to an embodiment of the present invention;

FIG. 3A is a flowchart of a method for producing electronically signed documents via a proxy and FIG. 3B is a flowchart of a method similar to the method illustrated in FIG. 3A and further comprising a confirmation step according to some embodiments of the present invention; and

FIG. 4 is an example of a confirmation request note according to an embodiment of the present invention.

It would be appreciated that for simplicity and clarity of the illustrations, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

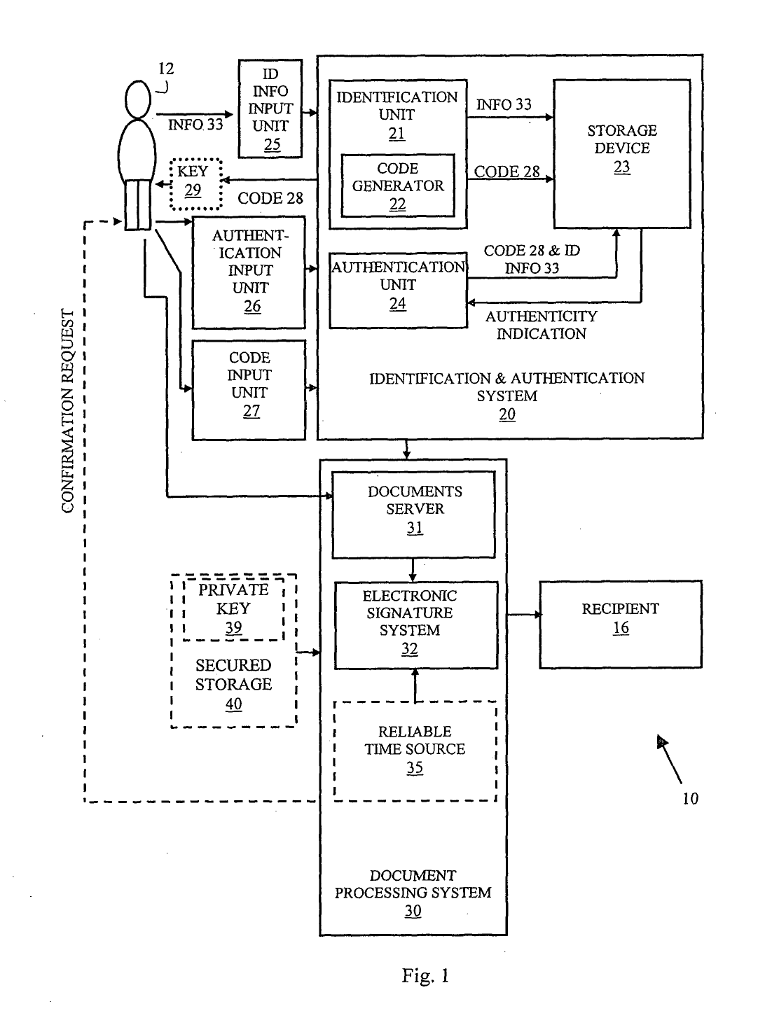

In the following detailed description, numerous specific details are set forth in to order to provide a thorough understanding of the invention. However, it will be understood by those skilled in the art that the present invention may be practiced without these specific details. In other instances, well-known methods, procedures, and components have not been described in detail so as not to obscure the present invention. Reference is made to FIG. 1, which is a schematic block diagram of a system for signing of documents via proxy, according to one embodiment of the present invention. Signature via proxy system 10 may comprise identification and authentication sub-system 20 and a documents processing sub-system 30.

Identification and authentication system 20 may comprise identification unit 21 adapted to receive identification information 33 such as an e-mail address from user 12, via information input means 25, process the information 33, optionally store a representation of at least a portion of the information 33 in storage device 23 and produce by code generator 22, a secret authentication code 28 that is undoubtedly associated with user 12, to be provided to user 12 for future identity authentication. Code 28 provided to a user may be, for example, a series of numbers and letters to be manually entered by user 12 when authentication is required. However, other types of representation of code 28 may be used. According to another or additional embodiment code 28 that is provided to user 12 may be embedded or stored in a key device 29, such as a magnetic card, a Radio Frequency Identification (RFID) card, a portable storage device such as a “disk-on-key” device, or a magnetic media etc. Code 28 generated by code generator 22 may be stored, together with identification information 33 received form user 12, in storage device 23. It would be appreciated however, that according to some embodiments of the present invention, a code may not be generated and provided to user 12 but rather provided by user 12 together with other identification information 33 received from user 12. In yet another embodiment a code may not be required at all, and identification and authentication (though weak) may be based on identification information provided by user 12 in advance (e.g. upon registration to the system). The level of authentication is application and implementation specific.

According to yet another embodiment of the present invention storage device 23 may be included in identification and authentication system 20 or may be located in a remote location. According to one embodiment of the present invention storage device 23 may be a hard drive storage means, such as Random Access Memory (RAM), Flash memory device, etc. Storage device 23 is preferably securable.

Identification and authentication system 20 may further comprise an authentication unit 24. Authentication unit 24 may be in active communication with an authentication information input means 26 adapted to allow user 12 to input identification information 33, and in active communication with code input means 27 to allow user 12 to enter authentication code 28.

Any and all of information input means 25, 26 and 27 may be combined with each other so that a single input means serves for inputting one, more than one or all required information, or may be separated into separate input units, as may be suitable. Input means may comprise a keyboard, a card reader, portable storage reader and a means capable of reading key device 29 and so forth. According to another embodiment of the present invention, the information input means may consist a Dual Tone Multi Frequency (DTMF) receiving device, adapted to receive data coded according to DTMF conventions, for example from a telephone supporting receiving and transmitting of DTMF coded data. In yet another embodiment Short Message Service (SMS) may be used in order to authenticate the identity of user 12, for example by interpreting the cellular phone number (sender's ID) as the identification code, and the SMS body including the authentication code 28 typed by user 12. In a further embodiment of the present invention voice recognition systems may be used in order to identify and/or authenticate the identity of user 12. In another or additional embodiment of the present invention, information input means may comprise a biometric sensor to obtain identification biometric data from user 12. The biometric sensor according to one embodiment of the present invention may be a fingerprint scanner, a voice recognition system or any other biometric sensor known in the art. It would be appreciated that a cellular phone or any other kind of telephone may be used as an information input means, e.g. for voice or code entry as described above.

The input means may be attached physically to identification and authentication system 20 or may be positioned remotely from identification and authentication system 20 and may communicate with it through a communication line or communication channel such as the Internet.

Authentication code 28 may in some cases be provided by user 12 rather than by code generator 22, e.g. in case where user 12 selects the authentication code (which in some embodiments may be a password) himself, or in case where a voice recognition system is used to implement authentication input unit, and the user needs to provide a sample of his voice.

Authentication unit 24 may be connected to storage device 23 in order to enable comparing identification information and authentication code provided by user 12 to authentication unit 24 with identification information 33 and authentication code 28 stored in storage device 23, in order to authenticate the identity of user 12. Different embodiments of the present invention may require different degree of authentication.

According to one embodiment a two-factor authentication process may be required: user 12 may be in possession of a specific hardware device and a code such as a password. When authentication is required, user 12 may be required to prove he is in possession of the hardware and with knowledge of the password. Only if the two factors requirement is met (something user 12 has and something user 12 knows), a positive authentication of user's 12 identity is established. According to one embodiment of the present invention, the user 12 may be in possession of a cellular phone (a hardware device). A request for confirmation may be sent to a cellular phone number provided by user 12 in advance, whereby user 12 may be required to provide the authentication code 28. It is appreciated however that some less restrictive embodiments may utilize a single factor authentication or any other suitable authentication scheme in the context of the present invention.

Documents processing system 30 may comprise documents server 31 adapted to receive documents from user 12, and an electronic signature system 32 to electronically sign, on behalf of user 12, documents received from user 12, utilizing an electronic signature owned by a proxy of user 12, and for sending the electronically signed documents to a designated recipient 16. The proxy may be any person or entity authorized to and having the capability to electronically sign documents with whom user 12 has established, or is about to establish proxy relations, i.e., relations empowering the proxy to electronically sign on behalf of user 12 documents provided by user 12. Documents processing system 30 may be implemented for example in a manner similar to a Webmail (e.g. GMAIL®) or SMTP daemon (e.g. Sendmail MTA) e-mail server. Documents processing system 30 possesses the basic functionality of an e-mail server, i.e., receiving documents for transmission, and may further possess capability of signing them.

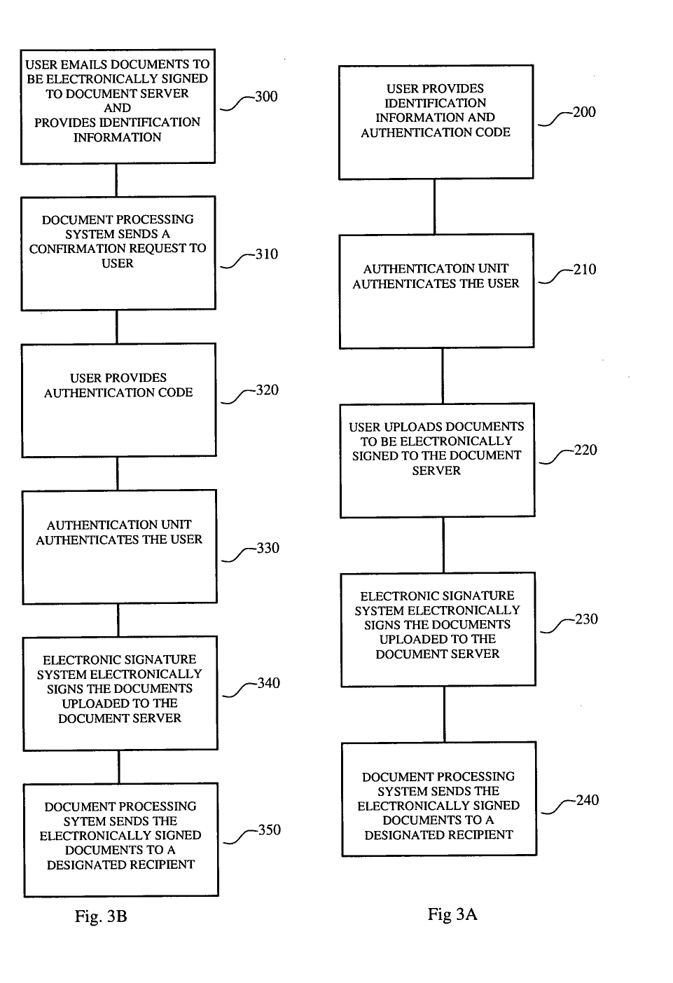

According to one embodiment of the present invention documents server 31 may be accessed by user 12 from a remote location through any kind of remote access means, such as via an Internet connection (not shown), to allow the upload of documents by user 12 to documents server 31. In another embodiment documents may be sent to documents server 31 by e-mail for example through a SMTP connection or uploaded through any known file uploading means, such as a communication network, a CD-ROM drive or via a Universal Serial Bus (USB) port or the like. In yet another embodiment of the present invention, user 12 may log into a website associated with, in communication with or otherwise linked to documents server 31, and compose a message and attach, or upload, documents in a similar manner to uploading documents to Web-Mail services known in the art. In such embodiment, the authentication process is accomplished upon user 12 logging into the website linked to documents server 31 (see also for example FIG. 3A below). In yet another embodiment of the present invention, documents can be sent to documents server 31 by fax transmission, where an image file of the transmitted documents is generated, e.g. in TIF format, on documents server 31 in a manner similar to those generated by widely available fax-to-email services or any other hard copy to soft copy services know in the art.

Electronic signature system 32 may incorporate means for electronically signing, on behalf of user 12, documents provided to documents server 31, optionally after converting the documents to another, more suitable format. According to an embodiment of the present invention, electronic signature system 32 may have access to private key 39, owned by the proxy of user 12, usable for applying an electronic or digital signature to a document which is sent or uploaded by user 12 to documents server 31. The signature may for example be implemented according to a Symmetric or Asymmetric Key Cryptosystem scheme such as RSA or DSA, or any other electronic signature scheme known in the art. Private key 39 may be embedded or otherwise stored on a RFID card, an USB dongle or any other securable storage device 40 known in the art. It is appreciated that a storage device controlled or owned by a disinterested party other than user 12, even if not physically secured, shall be considered as having sufficient level of security for the purpose of this invention.

It would be appreciated that the documents might be signed individually, separately one by one, combined, or within some container such as by signing an e-mail message having attached within one or more documents. Once such container's signature is verified, it is appreciated that documents within that e-mail message are considered signed too.

In yet another embodiment of the present invention a time indication obtained from a reliable source 35 may be added to the signed document by electronic signature system 32. In the context of the present invention a reliable time source refers to a time source which cannot be tampered by either user 12 or recipient 16. In yet another embodiment of the present invention, a digital timestamp may be applied to documents provided by user 12, in conjunction with an electronic signature or separately as desired.

Digital timestamps are used to secure electronic documents and data and bind them to a point in time when they were timestamped. Timestamps are considered reliable and durable, and have similar security characteristics as electronic signatures, i.e. they enable detection of even the slightest change in the document they are applied to. However, they differ in that digital timestamps cannot prove who signed the documents, while electronic signature typically cannot prove when a document was signed. Timestamps can be used, for example, to verify that a digital signature was applied to a document before the corresponding certificate was revoked (deliberately or expired), thus allowing a revoked public key certificate to be used for verifying signatures created prior to the time of revocation. Therefore electronic signatures are often used in conjunction with digital timestamps. Often the digital timestamp is applied to the electronically signed document or to the electronic signature itself. It is appreciated however, that if the signer's (proxy) identity is established in a different manner (e.g. by using a seal or stamp, or otherwise), then a digital timestamp may be applied alone. Timestamps may be applied for example using the protocol described in RFC 3161.

In yet another embodiment of the present invention, the signed documents may be electronically sent to a designated recipient whose e-mail address or other electronic delivery details are provided by user 12. In one embodiment, the signed documents may be sent via registered e-mail services such as RPost.com® or Rashum.Com—which provide proof of delivery and contents of electronic transmissions submitted using them.

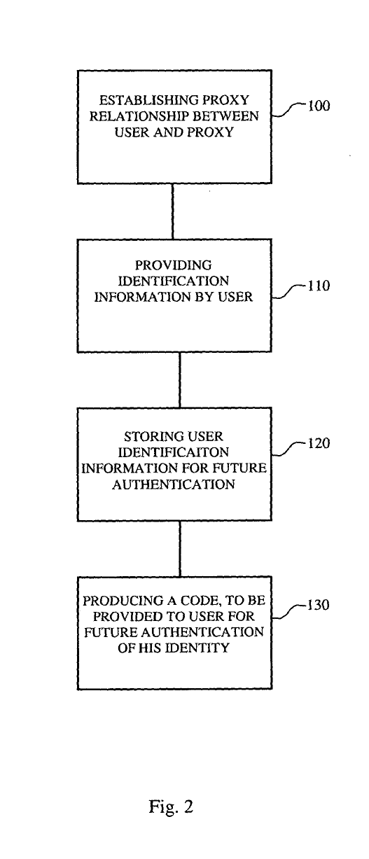

Reference is made now to FIG. 2, which is a schematic flowchart of a method for authenticated communication between a user and a proxy, according to an embodiment of the present invention (referred to herein as the registration process) and may comprise of the following steps (the referrals indicated below refer to the entities and elements with same referrals depicted in FIG. 1):

Establishing proxy relationship between user 12 and a proxy [block 100]. The relationship may be established according to the common practice and legal requirements in the jurisdiction of interest such as signing a power of attorney empowering the proxy to sign documents on behalf of user 12. In another embodiment it may be sufficient for user 12 to submit a signed registration form to the proxy optionally accompanied with a photocopy of some identification document to establish the proxy relationship. Proxy relationship may be established once in advance for a series of transactions or may be established on a single transaction basis.

Providing identification information 33 by user 12 [block 110] and storing the information 33 provided by user 12 in storage device 23 for future authentication of identity of user 12 [block 120]. The information 33 may include distinguishing information such as any or all of a list comprising: full name, address, e-mail address, identification card number, passport number, a telephone number, fax number, a cellular phone number.

Producing a secret authentication code 28 undoubtedly associated with user 12 identification information 33, to be stored in storage device 23 and compared against future code provided by user 12 for authentication of his identity [block 130]. As discussed hereinabove, the code may be produced by code generator 22 or determined or provided by user 12, as appropriate.

Reference is made now to FIG. 3A which is a flowchart of a method for producing electronically signed documents via a proxy according to an embodiment of the present invention, which can be implemented for example using a Web-Mail style website. The method may comprise of the following steps:

User 12 may log-in to electronic signature-via-proxy system 10, by providing identification information 33 and authentication code 28 [block 200]. User 12 may provide the identification information 33 and code 28 by using the authentication and code input means 26, 27.

Authentication unit 24 may authenticate the identity of user 12 by comparing identification information and authentication code provided by user 12 with those of said user 12 stored in storage device 23 [block 210].

After confirming a positive authentication of user 12's identity, user 12 may upload documents that should be electronically signed, to documents server 31 [block 220]. User 12 may further provide relevant information regarding designated recipient 16 to which the signed documents should be sent, such as recipient's address, recipient's e-mail, recipient's phone number etc. Documents server 31 may be accessed by user 12 from a remote location through any kind of remote access means, such as by a Web Browser on an Internet connection, to allow the upload of documents by user 12 to documents server 31. In another embodiment documents may be sent to documents server 31 by e-mail, for example through an authenticated SMTP connection, or uploaded through a files uploading means, such as a communication network, or a CD-ROM drive, a USB device, a portable hard drive or the like, directly connected to documents server 31.

Electronic signature system 32 electronically signs the documents uploaded to documents server 31 using electronic signature means [block 230] and optionally sends the electronically signed documents to a designated recipient 16 [block 240], using delivery address provided by user 12. In another embodiment of the present invention the signed documents may be sent to user 12 in addition to, or instead of sending the signed documents to the designated recipient. The signed documents sent to user 12 may serve as an official receipt. Thereafter the documents may be deleted from documents server 31, or kept for archive purposes, future reference or proof, or any other purposes as desired.

As illustrated in FIG. 3B, according to an embodiment of the present invention, the documents may be uploaded or sent to the documents server 31, prior to authentication [block 300]. In one embodiment of the present invention a confirmation request may be sent to user 12 prior to the signing or submission of the documents [block 310], in order to authenticate the identity of user 12 and to verify the user's intent to authorize the electronic signature of the documents on user's behalf. Upon receipt of the user's confirmation, for example by way of providing the authentication code [block 320], authentication unit 24 authenticates user 12 [block 330]. When a positive authentication has been determined, electronic signature system 32 may sign the uploaded documents [block 340] and send the electronically signed documents to the designated recipient 16 [block 350]. The embodiment illustrated in FIG. 3B may be suitable for providing the documents to the proxy via regular unauthenticated SMTP e-mail, and later confirm the transaction for example by logging-in to the proxy's website and providing an authentication code (e.g. a password).

An efficient method for producing ready-to-be-signed electronic documents may be implemented for example using a printer driver. A special printer driver may be installed at user 12's computer. The printer driver, instead of (or in addition to) printing normally to a printer, being capable of printing into a file, preferably a file having a commonly acceptable and recognized format, such as Adobe® PDF format. An example of such available printer driver is NovaPDF™. The advantage of utilizing a printer driver is that it is virtually application independent, i.e. any application being capable of printing into a printer, can print into the special printer driver without any special accommodations or adjustments. For example, the user can readily generate with any form generation application, forms in PDF file format instead of printing them to paper.

Using PDF format is a handy choice because it is widespread, portable, commonly used, and it is practically the de-facto document transfer standard. Moreover, the Acrobat® Reader application which exists on almost every computer can be used to check, verify, validate, view and print signed PDF files.

PDF documents can be signed for example by using SecureSoft's PDF Signer™ digital signature software. The signature may indicate in the “Reason” field that the signature is made on behalf of the specific user 12 and optionally indicate his name. In another embodiment, a timestamp can be added as well.

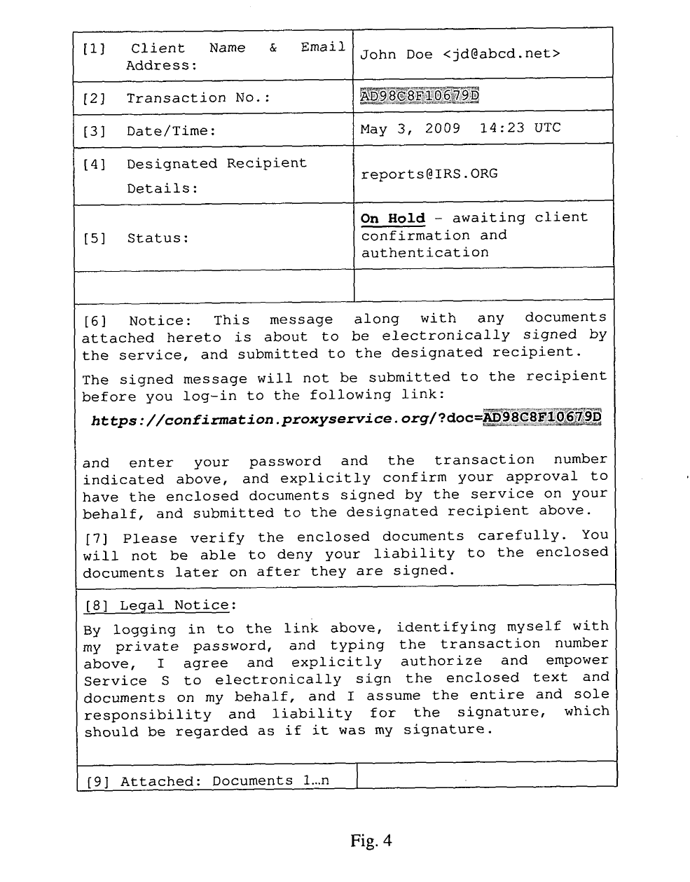

FIG. 4 is an example of a confirmation request note according to an embodiment of the present invention. A confirmation request may be sent by documents processing system 30 to user 12 via, for example, electronic mail to an electronic mail address provided by user 12 at the registration process described above in FIG. 2. According to yet another embodiment of the present invention, a confirmation request may be sent by a Short Message Service (SMS) to a cellular phone number provided in advance by user 12. The confirmation request note may include part or all of the following data:

User's name and e-mail address [1];
Transaction number [2];
Date and time [3];
Designated recipient details [4];
Status information [5]; and
General information and instructions [6]-[9].

Upon reception of the confirmation request note, user 12 becomes aware that some documents are about to be signed on his behalf and that signature via proxy system 10 awaits his authentication and approval of the process. Such procedure also protects user 12 from potential frauds that may be performed on his behalf. User's confirmation may be received via a website where user 12 will be requested to enter authentication information 28 and optionally further provide the transaction number incorporated in the confirmation request note or any other information that may confirm that user 12 approves the signature and delivery of the documents to the designated recipient 16. Furthermore, user may be requested to verify the documents and to approve the signature by the proxy on user's behalf.

According to yet another embodiment, confirmation may be received via e-mail or SMS including authentication code and optionally the transaction number.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for providing proxy signature to user documents comprising:
an identification and authentication system;
an information input means to enable providing identification information by said user to said system;
an authentication information input means to enable providing authentication information by said user to said system;
an electronic signature system; and
a documents server for receiving documents from user for electronic signature
wherein said identification and authentication system comprises:
a storage device,
an identification sub-system adapted to receive identification information from said user via said information input means and store said identification information in said storage device, and
an authentication sub-system adapted to authenticate the identity of said user based on information stored in said storage device and information provided by user during authentication process via said authentication information input means, and
wherein said electronic signature system is adapted to apply a signature to documents provided by said user to said documents server.

2. The system of claim 1 further comprising a reliable time source adapted to allow adding a time indication to said signed documents.

3. The system of claim 1 comprising means for adding a digital timestamp to said signed document.

4. The system of claim 1, wherein said signature is an electronic signature.

5. The system of claim 4 wherein said electronic signature is a digital signature.

6. The system of claim 1 wherein said identification sub-system comprises a code generator adapted to produce a code to be associated with said identification information of said user, said code is to be provided to said user for future authentication of said user's identity.

7. A method for signing documents of a user via a proxy comprising the steps of:
authenticating the identity of said user;
receiving from said user documents to be signed by proxy; and
electronically signing said documents, by proxy on behalf of said user according to empowerment delegated by said user.

8. The method of claim 7 further comprising the step of converting said documents received from said user to another format prior to signing said documents by said proxy.

9. The method of claim 7 further comprising the step of sending said signed documents to a recipient designated by said user.

10. The method of claim 7 further comprising the step of having said proxy identify and authenticate the identity of said user.

11. The method of claim 10 further comprising the step of storing identification information associated with said user.

12. The method of claim 11 further comprising the step of associating said user with a unique identification code to be associated with said identification information.

13. The method of claim 9 further comprising the step of sending to said user a request to confirm empowerment of proxy and intention to send said documents prior to signing and sending said documents to a recipient.

14. The method claim 7 wherein said documents are generated by printing from an information processing application into a printer driver which generates electronic documents.

15. The method of claim 7 further comprising the step of digital timestamping said documents, the signature part, or any portion thereof.

16. The method of claim 7 wherein said step of electronic signing is performed using a digital signature.

17-20. (canceled)
